(19) United States
(12) Patent Application Publication
(10) Pub. No.: US 2007/0252716 A1
(43) Pub. Date: Nov. 1, 2007

(54) Solar Inverter and Photovoltaic Installation Comprising Several Solar Inverters

(76) Inventor: Roland Burger, Aichstetten (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/597,765

(22) PCT Filed: May 25, 2005
(86) PCT No.: PCT/EP05/05678

§ 371 Date: Nov. 27, 2006

(30) Foreign Application Priority Data
May 27, 2004 (DE) 10 2004 025 924.0

(51) Int. Cl. G08B 21/00; H02M 7/00

(52) U.S. Cl. 340/635

(57) ABSTRACT

In one aspect, a solar inverter which can be connected to at least one photovoltaic generator at the input end and to a power system at the output end is provided. The solar inverter includes an inverter module, an electronic control unit at least for diagnosing an inverter module, and a bus interface for technically connecting the electronic control unit to a communication bus. The electronic control unit cyclically outputs a piece of status information of the solar inverter on the communication bus, and outputs an error message on the communication bus, cyclically reads status information of other solar inverters that are connected to the communication bus, and outputs an error message on the communication bus in case at least one expected additional piece of status information fails to be output. Whereby, the need for a separate monitoring unit is eliminated.

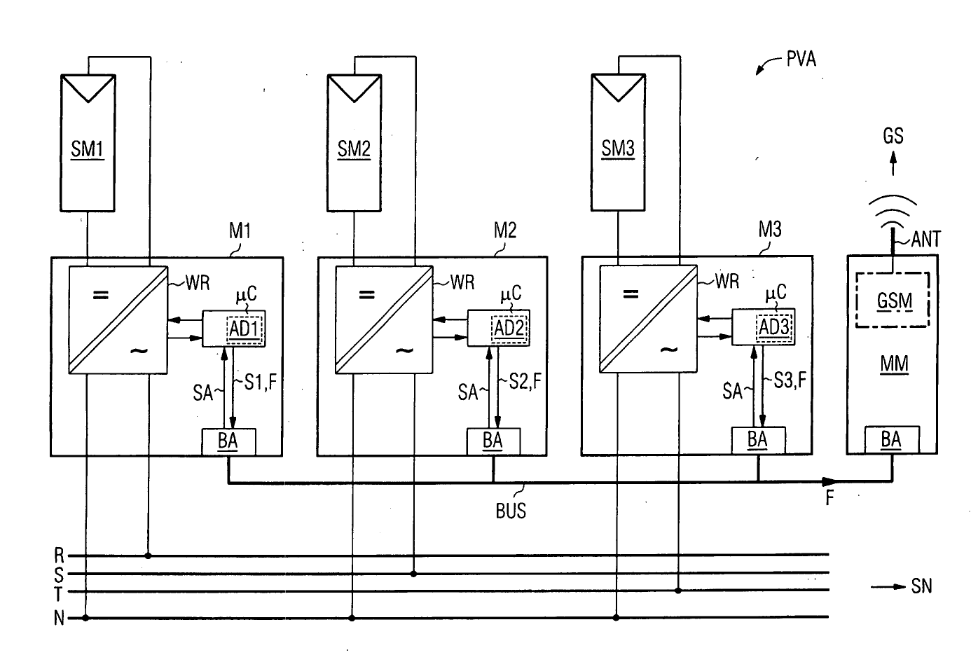

### CROSS REFERENCE TO RELATED APPLICATIONS

This application is the US National Stage of International Application No. PCT/EP2005/005678, filed May 25, 2005 and claims the benefit thereof. The International Application claims the benefits of German application No. 102004025924.0 filed May 27, 2004, both of the applications are incorporated by reference herein in their entirety.

### FIELD OF INVENTION

The invention relates to a solar inverter which can be connected to at least one photovoltaic generator at the input end and to a power system, in particular a public power system, at the output end and has at least one inverter module, an electronic control unit, at least for carrying out diagnostics on an inverter module, and a bus interface for establishing a data processing connection between the electronic control unit and a communication bus.

The invention relates to a photovoltaic installation for effecting a feed into a power system, in particular a public power system, with several solar inverters, to which at least one photovoltaic generator can be connected.

### BACKGROUND OF INVENTION

Photovoltaic installations are used for feeding electrical current into a power system, such as a single-phase 50 Hz/230V voltage supply system or a 3-phase 50 Hz/400V voltage supply system, for example. To this end, photovoltaic installations can have one or more photovoltaic generators, it being possible for a photovoltaic generator to consist of one or more solar modules, which in turn can have a plurality of interconnected solar cells. In this respect the solar cells of a solar module are usually connected in series as a “string”, particularly in a meander pattern. The electrical current generated by photovoltaic means is then fed to one or more solar inverters which convert(s) the direct voltage thus fed into a regulated, standardized system voltage. Solar inverters of this type are known for single-phase implementations, e.g. in DE 196 42 522 C1.

In addition, a photovoltaic installation can have a system control level for effecting control and operational management of a plurality of connected solar inverters.

With regard to photovoltaic installations, it can happen—as is generally the case with regard to technical equipment—that individual or even multiple solar inverters fail due to a technical defect. If this defect is not identified by the installation control system, this results in yield losses and ultimately leads to financial losses for the operator of the installation.

A known approach for avoiding the above-mentioned problems is to make provision in the installation for a monitoring device which monitors the respective solar inverters and which promptly reports the failure of such a device to a signaling or control point. To this end, such a monitoring device can, for example, be connected to a signaling facility for forwarding the captured error message, such as a radio-enabled GSM module, for example.

Another technical solution provides for interrogating the respective solar inverters on a cyclical basis by using a PC, i.e. a “personal computer”. In this respect the PC itself is connected to the devices, which are usually situated remotely, by way of a telephone connection or by way of an Ethernet connection. A special software application on the PC interrogates the status of the individual solar inverters at regular intervals. In the event of a fault situation, the operator of the installation then receives a suitable message.

U.S. Pat. No. 6,362,540 B1 discloses a system which, in addition to a monitoring device, also has an additional PC which takes over the monitoring finction if a fault occurs in the monitoring device.

### SUMMARY OF INVENTION

A disadvantage of the first solution described is the fact that a separate monitoring device has to be provided, which represents an additional investment for the operator of a photovoltaic installation.

A disadvantage of the second solution is the fact that an additional PC with a special software application is needed to be able to carry out a regular check on the installation.

It is therefore an object of the invention to specify a solar inverter and also a photovoltaic installation which does not need the above-mentioned additional monitoring devices.

The object is achieved with a solar inverter which can be connected to at least one photovoltaic generator at the input end and to a power system at the output end and has at least one inverter module, an electronic control unit, at least for carrying out diagnostics on an inverter module, and also a bus interface for establishing a data processing connection between the electronic control unit and a communication bus. According to the invention, the electronic control unit has means for effecting cyclical output of a piece of status information of the respective solar inverter on the communication bus, means for effecting cyclical readout of pieces of status information of further solar inverters that are connected to the communication bus, and also means for effecting output of an error message on the communication bus in the case of the absence of at least one expected further piece of status information.

The reciprocal monitoring of a plurality of solar inverters connected to the communication bus enables prompt detection of a failed solar inverter which can now no longer perform cyclical signaling. As a result a separate monitoring unit can be advantageously dispensed with.

In the simplest case, the status information can comprise a 1-bit piece of information that indicates whether the respective inverter module is working properly or not. Moreover, the solar direct current flowing into the inverter module at the input end at the time, the voltage applied to the connected photovoltaic generator, and also the system current fed into the power system at the time, for example, can also be output as a data value on the communication bus on a cyclical basis.

In a first embodiment, the solar inverter has a unique bus address with the result that said solar inverter can be addressed directly by way of the bus interface. As a result, each individual solar inverter can be parameterized and configured, for example in the context of commissioning the photovoltaic installation. This can be done, for example, by using a mobile diagnostic device which is connected to the communication bus during commissioning.

In a further embodiment, the electronic control unit of the respective solar inverter has means for effecting cyclical output of the piece of status information and also of the unique bus address of the solar inverter on the communication bus.

As a result, by way of advantage, a solar inverter that is now no longer signaling can be assigned by way of the bus address in the case of a fault and a corresponding error message sent.

It is also advantageously possible for an error message to be sent in the event of the existence of non-plausible pieces of status information of the respective solar inverters. This can occur, for example, if all the other solar inverters have roughly the same feed power, i.e., for example, roughly the same percentage value of the maximum possible feed power in each case and, for example, a further solar inverter reports a, by comparison with same, low solar current or none at all. The cause here can be, for example, the failure of a solar module of the photovoltaic generator, a discontinues conductor in the feed lines to the photovoltaic generator or major contamination of a solar module or a small number of solar modules.

In a further embodiment, the electronic control unit has an electronic memory, such as a RAM or EEPROM memory for example, for storing the respective bus addresses of the further solar inverters that signal on a cyclical basis by way of the communication bus. To this end, capture of the bus addresses of all the solar inverters that signal on a cyclical basis can be carried out for a certain length of time, such as one minute for example, during commissioning or upgrading of the photovoltaic installation, for example. These bus addresses can then be stored in the above-mentioned electronic memory in the form of a list. In the case of the failure of a solar inverter, this bus address can then be determined by means of comparison.

According to one embodiment, the cycle time for effecting cyclical output of the piece of status information on the communication bus and/or the cycle time for effecting cyclical readout of the further pieces of status information can be adjusted. These values can be stored in the electronic memory of the electronic control unit in the course of commissioning, for example. The cycle times can be of the order of a few seconds up to a few minutes, for example, with the result that an error message can still be sent promptly. If no cycle time is assigned during commissioning, the stored default time is used.

The electronic control unit comprises, in particular, a microcontroller. In this respect microcontrollers of this type also to some extent already have an integrated electronic memory for enabling storage of the above-mentioned bus addresses. It is also possible, by using a software program that can be executed on the microcontroller, to carry out both the control and regulation, and also the diagnostics for the inverter module connected to said microcontroller. Known microcontrollers have, among other features, both analog and digital input and output channels. By using the input channels, by way of advantage, the electrical input variables such as the current and voltage of a connected photovoltaic generator and/or the power system can be read in directly by way of a matching circuit and processed.

The microcontrollers frequently also already have an integrated bus interface. In the simplest case, this can comprise a so-called SPI port, for “Serial Port Interface”, for example.

In a further embodiment, the bus interface can be designed for communicating with a CAN BUS, a LAN, an RS232 bus, an RS485 bus or a USB, for example. This list is not exhaustive. Further bus systems are known to a person skilled in the art.

The object of the invention is furthermore achieved with a photovoltaic installation for effecting a feed into a power system with at least one solar inverter according to the invention, to which at least one photovoltaic generator can be connected.

In a particular embodiment, the photovoltaic installation has an electronic signaling module which includes a bus interface for establishing a data processing connection with the communication bus, means for receiving an error message originating from a solar inverter, and also means for sending the error message to a signaling or control point.

To this end, the signaling module can have a GSM and/or a UMTS transceiver module, a modem for effecting connection to a telephone network or a gateway for effecting connection to a “local area network”, i.e. a LAN, for example.

This is associated with the major advantage that firstly the signaling module can be implemented extremely compactly since the electronic components and fuinctional assemblies required for monitoring the respective solar inverters are not required. It is also possible to fashion the signaling module in such a way that said module has an electronic display for presenting the pieces of status information that are sent by the respective solar inverters on a cyclical basis. If the signaling module additionally has input keys, different pieces of status information to be displayed can also be selected.

In a particularly advantageous embodiment of the photovoltaic installation, the signaling module has electronic means, such as a simple microcontroller for example, in order to convert the error message received from the respective solar inverters into a corresponding e-mail message, fax or SMS text message.

This is associated with the advantage that the error message can be transferred promptly and in plaintext, directly on the spot, to a responsible person. It is particularly advantageous if the error message is forwarded as plaintext to a mobile telephone that the person to be monitored usually carries with him/her.

In a further variant, the solar inverter has the electronic means to convert an error message into an e-mail message, fax or SMS text message directly.

### BRIEF DESCRIPTION OF THE DRAWING

The invention is explained in more detail by way of example with reference to a sole figure with an exemplary illustration of photovoltaic installation PVA in accordance with the present invention.

### DETAILED DESCRIPTION OF INVENTION

In this arrangement the figure shows a photovoltaic installation PVA according to the invention which has, by way of example, three photovoltaic generators SM1-SM3. For reasons of clarity, their internal structure is not represented in further detail. In this case the photovoltaic generators SM1-SM3 provide a feed into one solar inverter M1-M3 each. In the example in the figure, each solar inverter M1-M3 has an inverter module WR which is connected to a photovoltaic generator SM1-SM3 at the input end. In this case the solar direct current is converted into a single-phase alternating voltage. For safety reasons, this voltage can, as already occurs in the present example, be potential-free with respect to the voltage level of the photovoltaic generators SM1-SM3.

In the example in the figure, the three solar inverters M1-M3 provide a feed into one phase R, S, T each of a power system SN in order to achieve a roughly even power distribution in said system SN. A system SN of this type is in particular a public 3-phase 50 Hz/400V voltage supply system. The neutral conductor shared by all three feeding solar inverters M1-M3 is designated by N.

Each solar inverter M1-M3 has a microcontroller μC as an electronic control unit. Said microcontroller is connected, for carrying out control, regulation, and monitoring and/or diagnostics for the associated inverter module WR, to said module by way of electrical connecting leads.

In the example in the figure, the microcontroller μC is additionally connected to a bus interface BA. Bus interfaces of this type are also obtainable as integrated components and tailored to the respective communication bus.

According to the invention, the microcontroller μC has means for effecting cyclical output of a piece of status information S1-S3 of the respective solar inverter M1-M3 on the communication bus BUS. Moreover, the microcontroller μC has means for effecting cyclical readout of pieces of status information SA from the communication bus BUS, which information the adjacent solar inverters M1-M3 and/or those belonging to the group jointly providing a feed also output on the communication bus BUS as their piece of status information S1-S3. Finally, the microcontroller μC has means for effecting output of an error message F on the communication bus BUS if at least one expected piece of status information SA of the other solar inverters M1-M3 should be absent.

By way of example the bus addresses AD1-AD3 are already integrated in an integrated electronic memory of the microcontroller μC according to the present figure.

According to the invention, the error message F is forwarded to a signaling module MM that also has a data processing connection with the communication bus BUS via a bus interface BA. In the example in the present figure, the signaling module MM has a GSM transceiver module GSM with a suitable antenna ANT in order to forward the error message F, which may be textually or graphically edited, in the form of an electronic message, for example, such as an SMS (for “Short Message Service”) text message, for example, to a predetermined recipient GS, such as a service technician, for example.

Signaling modules MM of this type based on GSM are also obtainable as commercial products and, by way of advantage, do not need to be developed separately for the photovoltaic installation PVA according to the invention.

1-13. (canceled)

14. A solar inverter effective that connects to a photovoltaic generator at the input end and connects to a power system at the output end, the solar inverter comprising:
an inverter module;
an electronic control unit effective to perform diagnostics on the inverter module; and
a bus interface effective to establish a data processing connection between the electronic control unit and a communication bus,
wherein the electronic control unit is effective to:
cyclically output a first status of the solar inverter on the communication bus,
cyclically read a second status of a second solar inverter connected to the communication bus, and
output an error message on the communication bus in the case of the absence of the second status.

15. The solar inverter as claimed in claim 14, wherein the solar inverter has a unique bus address.

16. The solar inverter as claimed in claim 15, wherein the electronic control unit is effective to cyclically output the unique bus address of the solar inverter on the communication bus.

17. The solar inverter as claimed in claim 16,
wherein the electronic control unit is effective to cyclically read a unique bus address of the second solar inverter via the communication bus, and
wherein the electronic control unit has an electronic memory for storing the bus addresses of the second solar inverter.

18. The solar inverter as claimed in claim 14, wherein the cycle time for effecting cyclical output on the communication bus is adjustable.

19. The solar inverter as claimed in claim 14, wherein the cycle time for effecting cyclical reads via the communication bus is adjustable.

20. The solar inverter as claimed in claim 14, wherein the electronic control unit is a microcontroller.

21. The solar inverter as claimed in claim 14, wherein the bus interface is embodied for communicating with a communication bus type selected from the group CAN BUS, LAN, RS232 bus, RS485 bus, and USB.

22. A photovoltaic installation for effecting a feed into a power system, comprising:
a solar inverter effective to connect to a photovoltaic generator, the solar inverter comprising:
an inverter module,
an electronic control unit effective for carrying out diagnostics on the inverter module, and
a bus interface effective for establishing a data processing connection between the electronic control unit and a communication bus,
wherein the electronic control unit is effective to:
cyclically output a first status of the solar inverter on the communication bus,
cyclically read a second status of a second solar inverter connected to the communication bus, and
output an error message on the communication bus in the case of the absence of the second status.

23. The photovoltaic installation as claimed in claim 22, further comprising an electronic signaling module that includes:
a bus interface for establishing a data processing connection with the communication bus,
a receiver effective for receiving an error message originating from the solar inverter, and
a sender effective for sending the error message to a signaling point.

24. The photovoltaic installation as claimed in claim 23, wherein the signaling module further includes a modem effective for connecting to a telephone network.

25. The photovoltaic installation as claimed in claim 24, wherein the error message is converted into a corresponding e-mail message, fax or SMS text message by the signaling module.

26. The photovoltaic installation as claimed in claim 22, wherein the signaling module further includes a GSM or a UMTS transceiver module.

27. The photovoltaic installation as claimed in claim 22, wherein the signaling module further includes a GSM and a UMTS transceiver module.

28. The photovoltaic installation as claimed in claim 22, wherein the signaling module further includes a modem effective for connecting to a telephone network.

29. The photovoltaic installation as claimed in claim 22, wherein the signaling module further includes a gateway for effecting connection to a local area network.

30. The photovoltaic installation as claimed in claim 22, wherein the error message is converted into a corresponding e-mail message, fax or SMS text message by the signaling module.

31. A photovoltaic installation for effecting a feed into a power system, comprising:
a first solar inverter effective to connect to a photovoltaic generator, the solar inverter comprising:
an inverter module,
an electronic control unit effective for carrying out diagnostics on the inverter module, and
a bus interface effective for establishing a data processing connection between the electronic control unit and a communication bus,
wherein the electronic control unit is effective to cyclically output a status of the first solar inverter on the communication bus; and
a second solar inverter effective to connect to a photovoltaic generator, the solar inverter comprising:
an inverter module,
an electronic control unit effective for carrying out diagnostics on the inverter module, and
a bus interface effective for establishing a data processing connection between the electronic control unit and a communication bus,
wherein the electronic control unit is effective to cyclically output a status of the second solar inverter on the communication bus,
wherein the electronic control unit of the first solar inverter is effective to:
cyclically read the status of the second solar inverter, and
output an error message on the communication bus in the case of the absence of the status of the second solar inverter, and
wherein the electronic control unit of the second solar invert is effective to:
cyclically read the status of the first solar inverter, and
output an error message on the communication bus in the case of the absence of the status of the first solar inverter.

32. The photovoltaic installation as claimed in claim 31, further comprising an electronic signaling module that includes:
a bus interface for establishing a data processing connection with the communication bus,
a receiver effective for receiving an error message originating from the first or second solar inverter, and
a sender effective for sending the error message to a signaling point.
